(19) United States
(12) Patent Application Publication
(10) Pub. No.: US 2008/0158162 A1
(43) Pub. Date: Jul. 3, 2008

(54) Method And Apparatus For Inputting Character Through Direction Input Unit

(76) Inventor: Jaewoo Ahn, Gyeonggi-do (KR)

Correspondence Address: IPLA P.A., 3580 WILSHIRE BLVD., 17TH FLOOR, LOS ANGELES, CA, 90010, US

(21) Appl. No.: 11/813,406

(22) PCT Filed: Jan. 5, 2006
(86) PCT No.: PCT/KR06/00047

§ 371 Date: Jul. 5, 2007

(30) Foreign Application Priority Data
Jan. 5, 2005 (KR) 10-2005-0000712
Jan. 5, 2006 (KR) 10-2006-0001269

(51) Int. Cl. G06F 15/02; G06F 3/033

(52) U.S. Cl. 345/168

(57) ABSTRACT

Disclosed is a method and apparatus for inputting characters through a direction input unit such as a joystick. The method of inputting characters corresponding to keys arranged on a 4-by-3 keypad by means of a direction input unit having direction buttons indicating up, down, left, and right movements, the method including: (a) assigning two direction buttons of the direction input unit to each of the keys and selecting one of the keys by pressing the direction buttons of the direction input unit; and (b) outputting a character corresponding to the selected key according to a current character mode, and sequentially changing characters corresponding to the selected key one by one and outputting a selected character other than a previous character when the key is re-selected within a predetermined time, when a supplemental button other than the direction buttons is input within a predetermined time after the key is selected, or when one of the two direction buttons being pressed is released and re-pressed.

### TECHNICAL FIELD

The present invention relates to a method and apparatus for inputting characters through a direction input unit such as a joystick.

### BACKGROUND ART

In general, a direction input unit, such as a joystick, includes four direction buttons indicating up, down, left, and right movements, and one or two supplemental buttons. The joystick is a tool designed to select directions rather than to input characters. Conventionally, in order to input characters by means of the direction buttons of the joystick, an operation sequence of the direction buttons is set to correspond to each of the characters, or a virtual keyboard is provided on a display unit so that a user can input the characters on the keyboard by means of the direction buttons.

However, the conventional method has a problem in that a user needs to memorize the operation sequence of direction buttons corresponding to each of the characters and needs to operate the direction buttons a lot of times to select keys on the virtual keyboard.

### DISCLOSURE OF INVENTION

### Technical Solution

The present invention provides a method and apparatus for inputting characters through a direction input unit with the reduced number of operation times.

### ADVANTAGEOUS EFFECTS

According to the present invention, it is possible to input characters only with simple operation in an apparatus having a direction input unit such as a joystick, such that users can input the characters efficiently and conveniently.

### BRIEF DESCRIPTION OF THE DRAWINGS

The above and other features and advantages of the present invention will become more apparent by describing in detail exemplary embodiments thereof with reference to the attached drawings in which:

FIGS. 1 to 3 illustrate examples of a typical direction input unit such as a joystick;

FIGS. 4 to 7 illustrate keypads each having 4-by-3 arrangement in which numerals, English alphabet, symbols, or Hangeul (Korean alphabet) are arranged according to an embodiment of the present invention;

FIGS. 8 and 9 illustrate arrangements of direction buttons of a direction input unit according to an embodiment of the present invention;

FIG. 10 illustrates a mapping relation between individual keys of a 4-by-3 keypad and direction and supplemental buttons according to an embodiment of the present invention;

FIG. 11 illustrates a mapping relation upon using the supplemental button in FIG. 10;

FIG. 12 illustrates a direction input unit equipped with a plurality of direction input units;

FIG. 13 illustrates a mapping relation between individual keys of a 4-by-3 keypad and direction buttons in an apparatus having direction buttons indicating up, down, left, right, and diagonal movements;

FIG. 14 illustrates a mapping relation between individual keys of a 4-by-3 keypad and direction buttons in an apparatus having direction buttons indicating diagonal movements;

FIG. 15 is a flow chart of a method of inputting characters according to an embodiment of the present invention; and

FIG. 16 is a block diagram of an apparatus for inputting characters according to an embodiment of the present invention.

### BEST MODE FOR CARRYING OUT THE INVENTION

According to an aspect of the present invention, there is provided a method of inputting characters corresponding to keys arranged on a 4-by-3 keypad by means of a direction input unit having direction buttons indicating up, down, left, and right movements, the method including: (a) assigning two direction buttons of the direction input unit to each of the keys and selecting one of the keys by pressing the direction buttons of the direction input unit; and (b) outputting a character corresponding to the selected key according to a current character mode, and sequentially changing characters corresponding to the selected key one by one and outputting a selected character other than a previous character when the key is re-selected within a pre-determined time, when a supplemental button other than the direction buttons is input within a predetermined time after the key is selected, or when one of the two direction buttons being pressed is released and re-pressed.

The step (a) may include assigning two direction buttons to each of eight keys other than a center key in an upper 3-by-3 arrangement of the 4-by-3 keypad so that the vector sum of directions indicated by the two direction buttons can correspond to a position of each of the keys from the center key, assigning left and right buttons of the direction input unit to the center key, and selecting one of the keys in the upper 3-by-3 arrangement by pressing the direction buttons of the direction input unit.

Preferably, when there is a plurality of the direction input units, two input buttons of the direction input unit assigned to each of the keys in the 4-by-3 keypad are selected from two of the direction input units one per each direction input unit and are input simultaneously or individually.

According to another aspect of the present invention, there is provided an apparatus for inputting characters corresponding to keys arranged on a 4-by-3 keypad by means of a direction input unit having direction buttons indicating up, down, left, and right movements, the apparatus including: one or two direction input units; and a processing unit allowing a user to select one of the keys, each being assigned two of the direction buttons of the direction input unit, by pressing the direction buttons, outputting a character corresponding to the selected key according to a current character mode, and sequentially changing characters corresponding to the selected key one by one and outputting a selected character other than a previous character when the key is reselected within a predetermined time, when a supplemental button other than the direction buttons is input within a predetermined time after the key is selected, or when one of the two direction buttons being pressed is released and re-pressed.

According to another aspect of the present invention, there is provided an apparatus for inputting characters corresponding to keys arranged on a 4-by-3 keypad by means of a direction input unit having direction buttons indicating up, down, left, right, and diagonal movements, the apparatus including: one or two direction input units; and a processing unit outputting one of the keys in a lower 1-by-3 arrangement of the 4-by-3 keypad, each being assigned direction buttons of the direction input unit, by pressing the direction buttons when a left key of the lower 1-by-3 arrangement corresponds to simultaneously inputting left and supplemental buttons or simultaneously inputting down-left and supplemental buttons, a right key of the lower 1-by-3 arrangement corresponds to simultaneously inputting right and supplemental buttons or simultaneously inputting down-right and supplemental buttons, and a center key of the lower 1-by-3 arrangement corresponds to simultaneously inputting down and supplemental buttons.

According to another aspect of the present invention, there is provided an apparatus for inputting characters corresponding to keys arranged on a 4-by-3 keypad by means of a direction input unit having direction buttons indicating diagonal movements, the apparatus including: one or two direction input units; and a processing unit outputting one of the keys in an upper 3-by-3 arrangement of the 4-by-3 keypad, each being assigned direction buttons of the direction input unit, by pressing the direction buttons when a numeral key ‘1’ corresponds to inputting an up-left button two times, a numeral key ‘4’ corresponds to sequentially inputting up-left and down-left buttons, a numeral key ‘7’ corresponds to inputting a down-left button two times, a numeral key ‘2’ corresponds to inputting up-left and up-right buttons sequentially or reversely, a numeral key ‘5’ corresponds to sequentially inputting up-left and down-right buttons or sequentially inputting up-right and down-left buttons, a numeral key ‘8’ corresponds to inputting down-left and down-right buttons sequentially or reversely, a numeral key ‘3’ corresponds to inputting an up-right button two times, a numeral key ‘6’ corresponds to sequentially inputting up-right and down-right buttons, and a numeral key ‘9’ corresponds to inputting a down-right button two times.

### MODE FOR THE INVENTION

Exemplary embodiments in accordance with the present invention will now be described in detail with reference to the accompanying drawings.

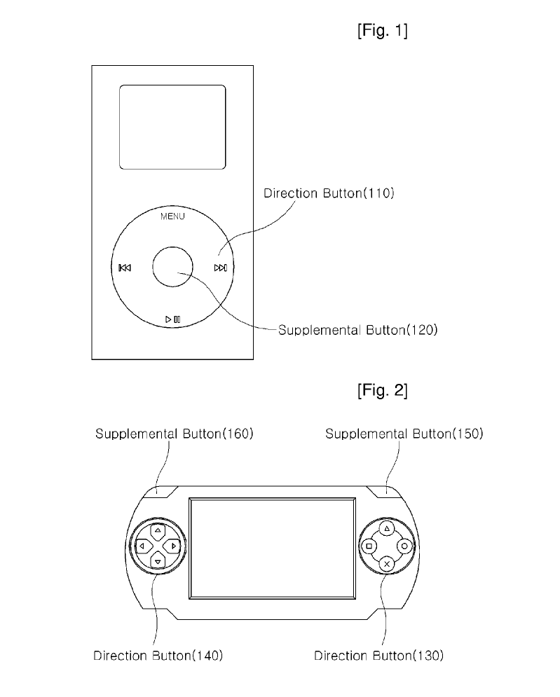

FIGS. 1 to 3 illustrate examples of a typical direction input unit such as a joystick.

The direction input units are used in various fields. In order to input directions, a user presses direction buttons 110, 130, and 140 indicating up, down, left, and right movements, or moves a direction stick 170 in up, down, left, and right directions.

In addition to the direction buttons 110, 130, and 140, or the direction stick 170, supplemental buttons 120, 150, 160, 180, and 190 are provided to perform supplemental functions such as selection or setup.

FIGS. 4 to 7 illustrate keypads each having 4-by-3 arrangement in which numerals, English alphabet, symbols, or Hangeul (Korean alphabet) are arranged according to an embodiment of the present invention.

As shown in FIGS. 4 to 7, numerals, English alphabet, symbols, and Hangeul are arranged on a 4-by-3 keypad and are input by means of a direction input unit according to the present invention. In FIG. 4, numerals are arranged in the same manner as those of a telephone having a typical 4-by-3 keypad. In FIGS. 5 to 7, English alphabet, symbols, and Hangeul are arranged in consideration of usage frequency or operation efficiency.

In the 4-by-3 keypad arranged in this manner, a character is input by selecting keys on the 4-by-3 keypad through one of the direction input units shown in FIGS. 1 to 3.

The numerals, English alphabet, symbols, or Hangeul are provided on the 4-by-3 keypad according to a selected character mode.

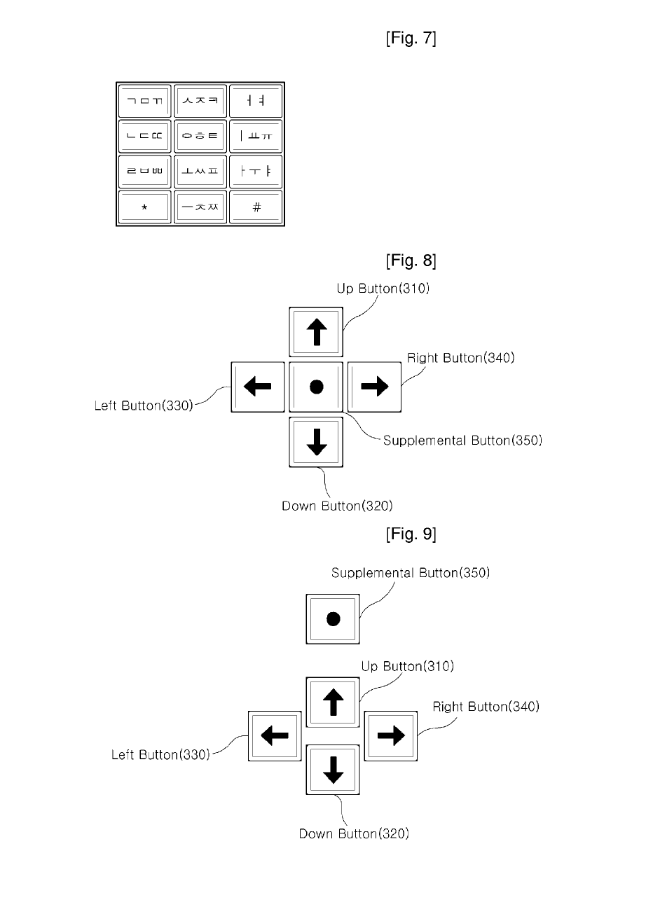

FIGS. 8 and 9 illustrate arrangements of direction buttons of a direction input unit according to an embodiment of the present invention.

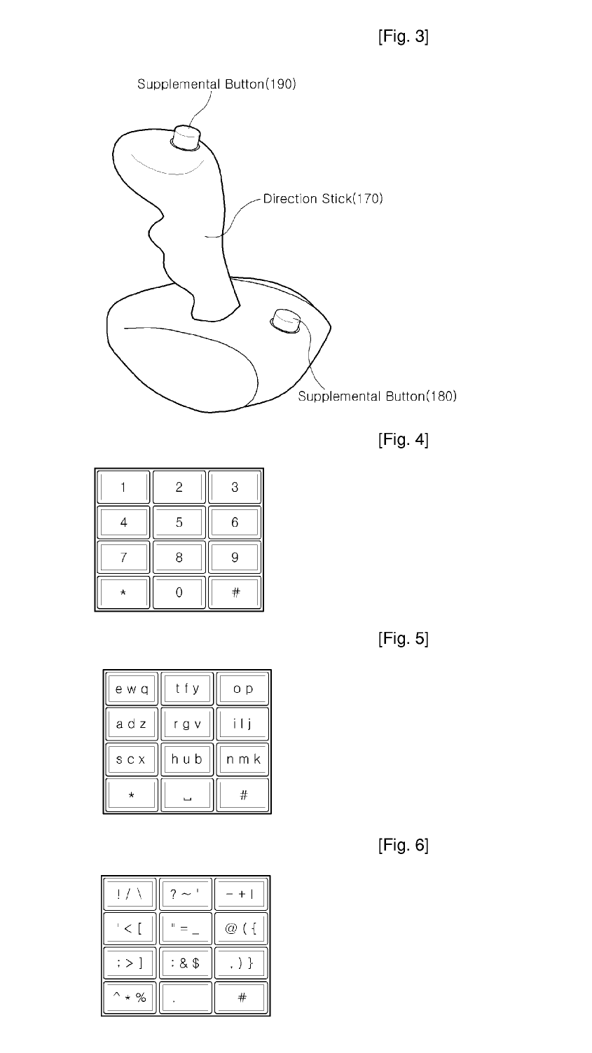

The present invention can be applied to various devices such as a direction input unit having direction buttons indicating up, down, left, and right movements as shown in FIGS. 1 and 2, or a direction input unit having a direction stick as shown in FIG. 3. In the present embodiment, a direction input unit having direction buttons will be described in detail.

A direction input unit includes an up button 310, a down button 320, a left button 330, and a right button 340. The direction input unit may further include a supplemental button 350 that is located at an upper side of the up button 310, a center of the buttons, or a right side of the right button 340. Characters assigned to individual 4-by-3 keypads shown in FIGS. 4 to 7 are input by means of the four direction buttons and the supplemental button. A method of inputting characters by means of the buttons 310 to 350 will be described in detail.

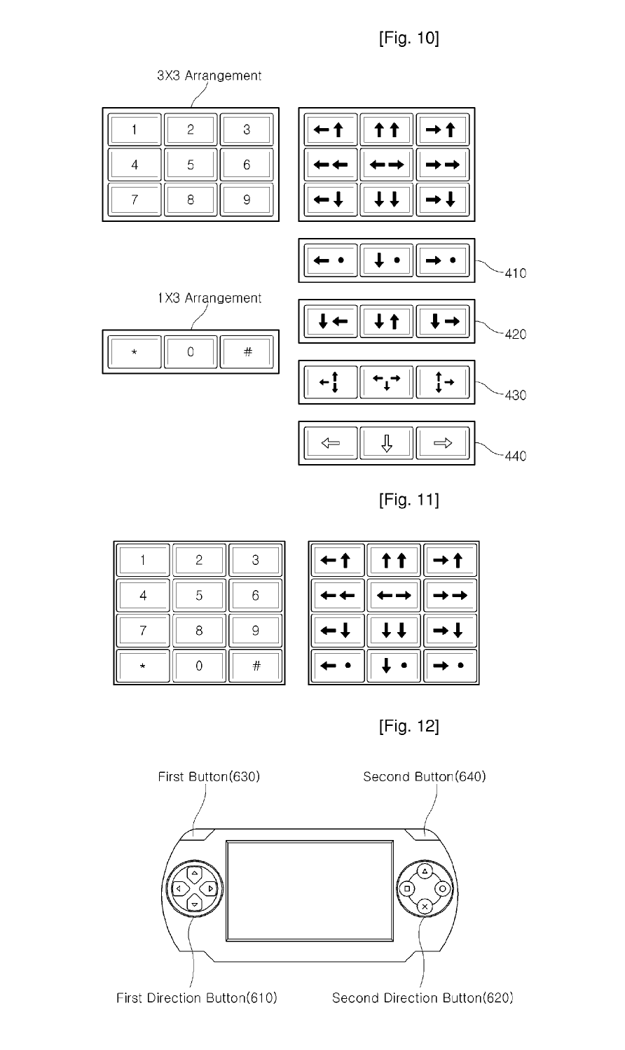

FIG. 10 illustrates a mapping relation between individual keys of a 4-by-3 keypad and direction and supplemental buttons according to an embodiment of the present invention.

Referring to FIG. 10, a numeral key ‘1’ corresponds to inputting a left button 330 and an up button 310, a numeral key ‘4’ corresponds to inputting the left button 330 two times, a numeral key ‘7’ corresponds to inputting the left button 330 and a down button 320, and a numeral key ‘2’ corresponds to inputting the up button 310 two times.

A numeral key ‘5’ corresponds to inputting the left button 330 and a right button 3 40, a numeral key ‘8’ corresponds to inputting the down button 320 two times, a numeral key ‘3’ corresponds to inputting the up button 310 and the right button 340, a numeral key ‘6’ corresponds to inputting the right button 340 two times, and a numeral key ‘9’ corresponds to inputting the down button 320 and the right button 340.

That is, two direction buttons are assigned to each of eight keys other than a center key in an upper 3-by-3 arrangement of the 4-by-3 keypad so that the vector sum of directions indicated by the two direction buttons can correspond to a position of each of the eight keys from the center key, and left and right buttons of the direction input unit are assigned to the center key. A corresponding one of the keys in the upper 3-by-3 arrangement is selected by pressing the direction buttons of the direction input unit assigned to the key sequentially or reversely. In other words, since the numeral key ‘1’ is located at an upper-left side of the center key ‘5’, the numeral key ‘1’ is selected by inputting the up button 310 and the left button 330. Other keys are selected in a similar manner.

Each of the numeral keys may be selected by inputting the left or right button prior to inputting the up or down button. In addition, direction buttons having the same direction assigned to the numeral key 2, 4, 6, or 8 may be input only one time. Two direction buttons having different directions assigned to the numeral keys 1, 3, 5, 7, or 9 may be simultaneously input to select a corresponding numeral key.

A mapping relation in a lower 1-by-3 arrangement will be described in detail with reference to reference numerals 410 to 440.

In case of the reference numeral 410, a symbol ‘*’ corresponds to inputting a left button 330 and a supplemental button 350, a symbol ‘#’ corresponds to inputting a right button 340 and a supplemental button 350, and a numeral key ‘0’ corresponds to inputting a down button 320 and a supplemental button 350.

That is, the left and supplemental buttons of the direction input unit are assigned to a left key in the lower 1-by-3 arrangement of the 4-by-3 keypad, the down and supplemental buttons are assigned to a center key in the lower 1-by-3 arrangement, and the right and supplemental buttons are assigned to a right key the lower 1-by-3 arrangement. A corresponding one of the keys in the lower 1-by-3 arrangement is selected by inputting the direction buttons assigned to the key sequentially or simultaneously.

In case of the reference numeral 420, down and left buttons 320 and 330 of the direction input unit are assigned to a left key in the 1-by-3 arrangement, down and up buttons 320 and 310 are assigned to a center key in the 1-by-3 arrangement, and down and right buttons 320 and 340 are assigned to a right key in the 1-by-3 arrangement. A corresponding one of the keys in the lower 1-by-3 arrangement is selected by sequentially inputting the direction buttons assigned to the key.

In case of the reference numeral 430, direction buttons other than the right button 340 of the direction input unit are assigned to a left key in the lower 1-by-3 arrangement, direction buttons other than the up button 310 are assigned to a center key in the lower 1-by-3 arrangement, and direction buttons other than the left button 330 are assigned to a right key in the lower 1-by-3 arrangement. A corresponding one of the in the lower 1-by-3 arrangement is selected by simultaneously inputting the direction buttons assigned to the key.

In case of the reference numeral 440, the left button 330 of the direction input unit is assigned to a left key in the lower 1-by-3 arrangement, the down button 320 is assigned to a center key in the lower 1-by-3 arrangement, and the right button 340 is assigned to a right key in the lower 1-by-3 arrangement. A corresponding one of the keys in the lower 1-by-3 arrangement is selected by inputting the direction button assigned to the key for more than a predetermined time interval.

A backspace function corresponds to sequentially inputting the right and left buttons 340 and 330. A function of changing a character mode corresponds to inputting the up and supplemental buttons 310 and 350.

In addition, an operation of repeatedly changing a previous character mode or repeatedly deleting a character is performed by pressing the supplemental button 350 one time within a predetermined time after changing the character mode or deleting the character. When the supplemental button 350 is further pressed within a predetermined time, the operation of changing a previous character mode or deleting a character is further performed.

The numeral key can be replaced by the English alphabet, symbol, or Hangeul key as shown in FIGS. 4 to 7 as the character mode is changed. The English alphabet has a lowercase mode, an uppercase modes and a sentence mode. The sentence mode implies that a first letter of a sentence is an uppercase letter and the remaining letters are lowercase letters.

As shown in FIGS. 4 to 7, in case of the English alphabet, symbol, or Hangeul, a plurality of characters is assigned to a single key. There are various methods of selecting one of the characters. That is, a plurality of characters corresponding to a key is sequentially selected and output when the key is selected to input a character and two direction buttons corresponding to the key are re-pressed within a predetermined time to select the key, when a supplemental button other than the direction buttons is input within a predetermined time after the key is selected, or when two direction buttons assigned to the key are pressed and one of the two direction buttons being pressed is released and re-pressed.

For example, a method of using the supplemental button 350 to select a character will be described. When the left and up buttons 330 and 310 are pressed in an English alphabet mode to select a key ‘ewq’ corresponding to a numeral key ‘1’, an alphabet ‘e’ is selected when the supplemental button 350 is not pressed, an alphabet ‘w’ is selected when the supplemental button 350 is pressed one time, and an alphabet ‘q’ is selected when the supplemental button 350 is pressed one more time. That is, after one of characters assigned to a selected key is selected, the supplemental button 350 is pressed to select another character.

On the other hand, when two direction buttons of the direction input unit assigned to each of the keys in the 4-by-3 arrangement are pressed and a second one of the two direction buttons is pressed for more than a predetermined time, a character previously set to each of the keys may be selected and output or a command previously set to each of the keys may be performed.

In addition, when a key ‘*’ is selected in a character mode, a symbol is input and a mode returns to an original mode.

FIG. 11 illustrates a mapping relation upon using the supplemental button in FIG. 10

FIG. 12 illustrates a direction input unit equipped with a plurality of direction input units.

A game machine such as Playstation includes direction buttons 610 and 620 on the left and right sides of its input unit. Since the input unit has two direction buttons, it is easy to press two buttons simultaneously.

When there are two direction input units as described above, two input buttons of a direction input unit assigned to each of the keys in the 4-by-3 arrangement are selected from the respective direction input units and are input simultaneously or individually.

When two input buttons are input from one of the two direction input units, one of the keys in the lower 1-by-3 arrangement of the 4-by-3 keypad is selected. In this case, a left key in the lower 1-by-3 arrangement is selected when a left button is input, a center key in the lower 1-by-3 arrangement is selected when a lower button is input, and a right key in the lower 1-by-3 arrangement is selected when a right button is input. In addition, a character mode may be changed when an upper button is input, and a cursor for inputting a character may be moved when input buttons are input from another direction input unit.

When a key in the 4-by-3 arrangement is selected, one or two supplemental buttons 630 and 640 of each of the two direction input units may be pressed to sequentially change a plurality of characters corresponding to the selected key one by one or two by two and to output a selected character.

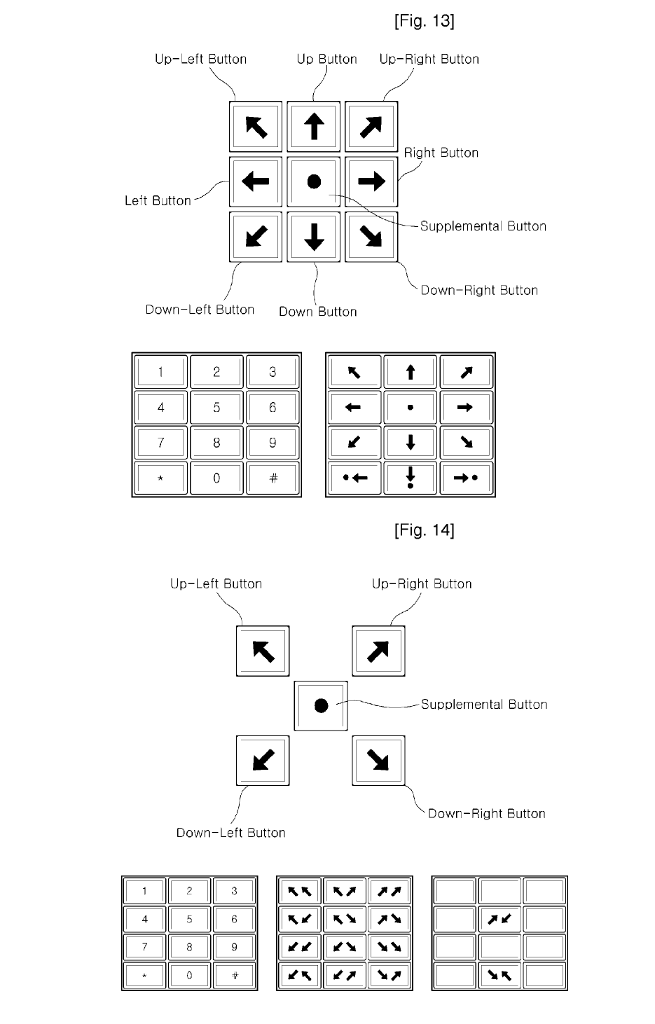

FIG. 13 illustrates a mapping relation between individual keys of a 4-by-3 keypad and direction buttons in an apparatus having direction buttons indicating up, down, left, right, and diagonal movements.

Referring to FIG. 13, each of eight keys other than a center key in the upper 3-by-3 arrangement of the 4-by-3 keypad are assigned two direction buttons so that the vector sum of directions indicated by the two direction buttons can correspond to a position of each key from the center key, and the center key is assigned a supplemental button. When the direction buttons are input, one of the keys in the upper 3-by-3 arrangement of the 4-by-3 keypad is selected.

On the other hand, a left key in the lower 1-by-3 arrangement of the 4-by-3 keypad corresponds to simultaneously inputting the left and supplemental buttons or simultaneously inputting the down-left and supplemental buttons. A right key in the lower 1-by-3 arrangement of the 4-by-3 keypad corresponds to simultaneously inputting the right and supplemental buttons or simultaneously inputting the down-right and supplemental buttons. A center key in the lower 1-by-3 arrangement of the 4-by-3 keypad corresponds to simultaneously inputting the down and supplemental buttons.

Another method of selecting one of the keys in the lower 1-by-3 arrangement is as follows. A left or down-left button of the direction input unit is assigned to a left key in the lower 1-by-3 arrangement, a down button of the direction input unit is assigned to a central key in the lower 1-by-3 arrangement, and a right or down-right button of the direction input unit is assigned to a right key in the lower 1-by-3 arrangement. One of the keys in the lower 1-by-3 arrangement may be selected by pressing direction buttons of the direction input unit assigned to each of the keys for more than a predetermined time.

FIG. 14 illustrates a mapping relation between individual keys of a 4-by-3 keypad and direction buttons in an apparatus having direction buttons indicating diagonal movements.

Referring to FIG. 14, the numeral key ‘1’ corresponds to inputting the up-left button two times. The numeral key ‘4’ corresponds to sequentially inputting the up-left button and down-left button. The numeral key ‘7’ corresponds to inputting the down-left button two times. The numeral key ‘2’ corresponds to inputting the up-left button and up-right button sequentially or reversely.

The numeral key ‘5’ corresponds to sequentially inputting the up-left button and down-right button or sequentially inputting the up-right button and down-left button. The numeral key ‘8’ corresponds to inputting the down-left button and down-right button sequentially or reversely. The numeral key ‘3’ corresponds to the up-right button two times. The numeral key ‘6’ corresponds to sequentially inputting the up-right button and down-right button. The numeral key ‘9’ corresponds to inputting the down-right button two times.

On the other hand, a left key in the lower 1-by-3 arrangement of the 4-by-3 keypad corresponds to sequentially inputting the down-left button and up-left button. A right key in the lower 1-by-3 arrangement corresponds to sequentially inputting the down-right button and up-right button. A center key in the lower 1-by-3 arrangement corresponds to sequentially inputting the down-left button and up-right button or sequentially inputting the down-right button and up-left button.

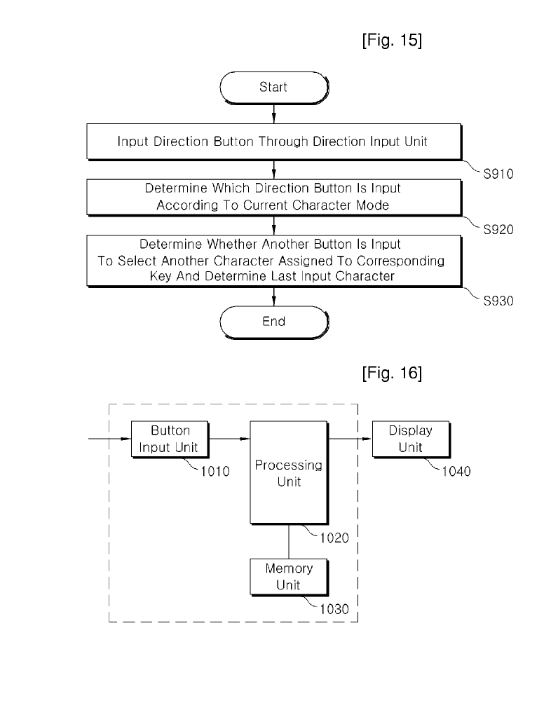

FIG. 15 is a flow chart of a method of inputting characters according to an embodiment of the present invention.

In order to input characters by means of a direction input unit such as a joystick, it is assumed that the characters are input in a character input mode rather than in a direction input mode.

A button input operation is performed through the buttons mapped as described above in a character input mode (S910). A corresponding one of the keys in the 4-by-3 keypad is determined from the input button according to a current character mode (S920). When there is a plurality of characters corresponding to the determined key, it is determined whether another button is further input to select one of the characters, and a last input character is determined (S930). A method of selecting one of the characters assigned to the selected key has been described above.

FIG. 16 is a block diagram of an apparatus for inputting characters according to an embodiment of the present invention.

The apparatus includes a button input unit 1010, a processing unit 1020, and a memory unit 1030. The button input unit 1010 may include one or two direction input units. The button input unit 1010 may have buttons indicating up, down, left, and right movements, or a stick movable in up, down, left, and right directions. Further, the button input unit 1010 may have a supplemental button.

The processing unit 1020 selects one of the keys in the 4-by-3 arrangement corresponding to buttons inputted from the button input unit 1010, and outputs a character assigned to the selected key on the display unit 1030 according to a current character mode. In this case, when the key is re-selected within a predetermined time, when a supplemental button other than direction buttons of the direction input unit is input within a predetermined time after the key is selected, or when one of the two input buttons being pressed is released and re-pressed, the processing unit 1020 sequentially changes a plurality of characters corresponding to the selected key one by one and outputs a selected character to the display unit 1040. A detailed description thereof has been given above.

In a case where the direction input unit includes input buttons indicating up, down, left, right, and diagonal movements as shown in FIG. 13, the processing unit 1020 outputs a character corresponding to direction buttons in the upper 3-by-3 arrangement when each of eight keys other than a center key in the upper 3-by-3 arrangement of the 4-by-3 keypad are assigned two direction buttons so that the vector sum of directions indicated by the two direction buttons can correspond to a position of each key from the center key, and the center key is assigned a supplemental button.

In addition, a left key in the lower 1-by-3 arrangement of the 4-by-3 keypad corresponds to simultaneously inputting the left and supplemental buttons or simultaneously inputting the down-left and supplemental buttons. A right key in the lower 1-by-3 arrangement of the 4-by-3 keypad corresponds to simultaneously inputting the right and supplemental buttons or simultaneously inputting the down-right and supplemental buttons. A center key in the lower 1-by-3 arrangement of the 4-by-3 keypad corresponds to simultaneously inputting the down and supplemental buttons.

Referring to FIG. 14, when the direction input unit includes buttons indicating diagonal movements, the processing unit 1020 outputs a character corresponding to direction input buttons when the numeral key ‘1’ corresponds to inputting the up-left button two times, the numeral key ‘4’ corresponds to sequentially inputting the up-left button and down-left button, the numeral key ‘7’ corresponds to inputting the down-left button two times, the numeral key ‘2’ corresponds to inputting the up-left button and up-right button sequentially or reversely, the numeral key ‘5’ corresponds to sequentially inputting the up-left button and down-right button or sequentially inputting the up-right button and down-left button, the numeral key ‘8’ corresponds to sequentially inputting the down-left button and down-right button sequentially or reversely, the numeral key ‘3’ corresponds to inputting the up-right button two times, the numeral key ‘6’ corresponds to sequentially inputting the up-right button and down-right button, and the numeral key ‘9’ corresponds to inputting the down-right button two times.

In addition, a left key in the lower 1-by-3 arrangement of the 4-by-3 keypad corresponds to sequentially inputting the down-left and up-left buttons. A right key in the lower 1-by-3 arrangement of the 4-by-3 keypad corresponds to sequentially inputting the down-right and up-right buttons. A center key in the lower 1-by-3 arrangement of the 4-by-3 keypad corresponds to sequentially inputting the down-left and up-right buttons or sequentially inputting the down-right and up-left buttons.

The memory unit 1030 may store the above-mentioned mapping relation between the keypad and the direction buttons, or a current character input mode.

On the other hand, the above-mentioned method of inputting a character can be written with a computer program. Codes and code segments constituting the program can be easily induced by computer programmers in the art. The program is stored in computer readable recording media and is read and executed by a computer to implement the above-mentioned method. Examples of the computer readable media include magnetic recording media, optical recording media, and carrier wave media.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be applied to a method and apparatus for inputting characters through a direction input unit such as a joystick.

1. A method of inputting characters corresponding to keys arranged on a 4-by-3 keypad by means of a direction input unit having direction buttons indicating up, down, left, and right movements, the method comprising:
(a) assigning two direction buttons of the direction input unit to each of the keys and selecting one of the keys by pressing the direction buttons of the direction input unit; and
(b) outputting a character corresponding to the selected key according to a current character mode, and sequentially changing characters corresponding to the selected key one by one and outputting a selected character other than a previous character when the key is re-selected within a predetermined time, when a supplemental button other than the direction buttons is input within a predetermined time after the key is selected, or when one of the two direction buttons being pressed is released and re-pressed.

2. The method of claim 1, wherein the step (a) includes assigning two direction buttons to each of eight keys other than a center key in an upper 3-by-3 arrangement of the 4-by-3 keypad so that the vector sum of directions indicated by the two direction buttons can correspond to a position of each of the keys from the center key, assigning left and right buttons of the direction input unit to the center key, and selecting one of the keys in the upper 3-by-3 arrangement by pressing the direction buttons of the direction input unit.

3. The method of claim 1, wherein the step (a) includes assigning left and right buttons of the direction input unit to a left key in a lower 1-by-3 arrangement of the 4-by-3 keypad, assigning down and supplemental buttons to a center key in the lower 1-by-3 arrangement, assigning right and supplemental buttons to a right key in the lower 1-by-3 arrangement, and selecting one of the keys in the lower 1-by-3 arrangement by pressing the direction buttons of the direction input unit sequentially or simultaneously.

4. The method of claim 1, wherein the selected character mode is changed upon pressing the up and supplemental buttons sequentially or simultaneously, and the character mode is continuously changed in a predetermined order when the supplemental button is further pressed within a predetermined time.

5. The method of claim 1, wherein a backspace command for deleting a single character is performed when the right and left buttons are sequentially pressed, and characters are further deleted one by one when the supplemental button is further pressed within a predetermined time.

6. The method of claim 1, wherein, in the step (a), when two direction buttons of the direction input unit assigned to each of the keys in the 4-by-3 keypad are pressed and one of the two direction buttons which is last input is pressed for more than a predetermined time, a predetermined character is output from each of the keys or a predetermined command is performed.

7. The method of claim 1, wherein the step (a) includes assigning a left or right button prior to an up or down button to each of the keys when the two direction buttons are assigned to each of the keys in the upper 3-by-3 arrangement of the 4-by-3 keypad,
sequentially assigning down and left buttons to a left key in a lower 1-by-3 arrangement of the 4-by-3 keypad,
sequentially assigning down and up buttons to a center key in the lower 1-by-3 arrangement,
sequentially assigning down and right buttons to a right key in the lower 1-by-3 arrangement, and
selecting each of the keys in the 4-by-3 keypad by sequentially pressing two direction buttons assigned to each of the keys.

8. The method of claim 1, wherein, in the step (a),
when two direction buttons assigned to each of the keys in the upper 3-by-3 arrangement of the 4-by-3 keypad are pressed to select a corresponding key, two direction buttons indicating different directions are simultaneously pressed and direction buttons indicating the same direction are pressed one time to select one of the keys in the upper 3-by-3 arrangement, and
when two direction buttons assigned to each of the keys in a lower 3-by-3 arrangement of the 4-by-3 keypad are pressed to select a corresponding key, two direction buttons assigned to each of the keys in the lower 1-by-3 arrangement of the 4-by-3 keypad are simultaneously pressed to select one of the keys in the lower 1-by-3 arrangement.

9. The method of claim 1, wherein the step (a) includes
assigning three direction buttons other than a right button of the direction input unit to a left key in a lower 1-by-3 arrangement of the 4-by-3 keypad,
assigning three direction buttons other than an up button of the direction input unit to a center key in the lower 1-by-3 arrangement of the 4-by-3 keypad,
assigning three direction buttons other than a left button of the direction input unit to a right key in the lower 1-by-3 arrangement of the 4-by-3 keypad, and
selecting each of the keys in the lower 1-by-3 arrangement by simultaneously pressing the three direction buttons assigned to each of the keys.

10. The method of claim 1, wherein the step (a) includes
assigning a left button of the direction input unit to a left key in a lower 1-by-3 arrangement of the 4-by-3 keypad,
assigning a down button of the direction input unit to a center key in the lower 1-by-3 arrangement,
assigning a right button of the direction input unit to a right key in the lower 1-by-3 arrangement, and
selecting each of the keys in the lower 1-by-3 arrangement by pressing the direction button assigned to each of the keys for more than a predetermined time.

11. The method of claim 1, wherein, when there is a plurality of the direction input units, two input buttons of the direction input unit assigned to each of the keys in the 4-by-3 keypad are selected from two of the direction input units one per each direction input unit and are input simultaneously or individually.

12. The method of claim 11, wherein
when input buttons are input from only one of the two direction input units, one of the keys in the lower 1-by-3 arrangement of the 4-by-3 keypad is selected, when the left button is input, the left key in the 1-by-3 arrangement is selected,
when the down button is input, the center key in the 1-by-3 arrangement is selected,
when the right button is input, the right key in the 1-by-3 arrangement is selected,
when the up button is input, a character mode is changed, and
when input buttons are input from the other direction input unit, a cursor for inputting a character is moved.

13. The method of claim 11, wherein
when one of the keys in the 4-by-3 keypad is selected, one or two supplemental buttons in each of the two direction input units are pressed to sequentially change a plurality of characters corresponding to the selected key one by one or two by two and to output a selected character other than a previous character.

14. An apparatus for inputting characters corresponding to keys arranged on a 4-by-3 keypad by means of a direction input unit having direction buttons indicating up, down, left, and right movements, the apparatus comprising:
one or two direction input units; and
a processing unit allowing a user to select one of the keys, each being assigned two of the direction buttons of the direction input unit, by pressing the direction buttons, outputting a character corresponding to the selected key according to a current character mode, and sequentially changing characters corresponding to the selected key one by one and outputting a selected character other than a previous character when the key is reselected within a predetermined time,
when a supplemental button other than the direction buttons is input within a predetermined time after the key is selected, or when one of the two direction buttons being pressed is released and re-pressed.

15. The apparatus of claim 14, wherein the processing unit is configured to select one of the keys in an upper 3-by-3 arrangement of the 4-by-3 keypad by pressing the direction buttons of the direction input unit when two direction buttons are assigned to each of eight keys other than a center key in the upper 3-by-3 arrangement so that the vector sum of directions indicated by the two direction buttons can correspond to a position of each of the keys from the center key, and left and right buttons of the direction input unit are assigned to the center key in the upper 3-by-3 arrangement.

16. The apparatus of claim 14, wherein the processing unit is configured to select one of the keys in a lower 1-by-3 arrangement of the 4-by-3 keypad by pressing the direction buttons of the direction input unit sequentially or simultaneously when left and right buttons of the direction input unit are assigned to a left key in the lower 1-by-3 arrangement, down and supplemental buttons are assigned to a center key in the lower 1-by-3 arrangement, and right and supplemental buttons are assigned to a right key in the lower 1-by-3 arrangement.

17. The apparatus of claim 14, wherein
when there is a plurality of the direction input units, the processing unit is configured to select two input buttons of the direction input unit assigned to each of the keys in the 4-by-3 keypad from two of the direction input units one per each direction input unit and to input the selected two input buttons simultaneously or individually.

18. An apparatus for inputting characters corresponding to keys arranged on a 4-by-3 keypad by means of a direction input unit having direction buttons indicating up, down, left, right, and diagonal movements, the apparatus comprising:
one or two direction input units; and
a processing unit outputting one of the keys in a lower 1-by-3 arrangement of the 4-by-3 keypad, each being assigned direction buttons of the direction input unit, by pressing the direction buttons when a left key of the lower 1-by-3 arrangement corresponds to simultaneously inputting left and supplemental buttons or simultaneously inputting down-left and supplemental buttons, a right key of the lower 1-by-3 arrangement corresponds to simultaneously inputting right and supplemental buttons or simultaneously inputting down-right and supplemental buttons, and a center key of the lower 1-by-3 arrangement corresponds to simultaneously inputting down and supplemental buttons.

19. An apparatus for inputting characters corresponding to keys arranged on a 4-by-3 keypad by means of a direction input unit having direction buttons indicating diagonal movements, the apparatus comprising:
one or two direction input units; and
a processing unit outputting one of the keys in an upper 3-by-3 arrangement of the 4-by-3 keypad, each being assigned direction buttons of the direction input unit, by pressing the direction buttons when a numeral key T corresponds to inputting an up-left button two times, a numeral key ‘4’ corresponds to sequentially inputting up-left and down-left buttons, a numeral key ‘7’ corresponds to inputting a down-left button two times, a numeral key ‘2’ corresponds to inputting up-left and up-right buttons sequentially or reversely, a numeral key ‘5’ corresponds to sequentially inputting up-left and down-right buttons or sequentially inputting up-right and down-left buttons, a numeral key ‘8’ corresponds to inputting down-left and down-right buttons sequentially or reversely, a numeral key ‘3’ corresponds to inputting an up-right button two times, a numeral key ‘6’ corresponds to sequentially inputting up-right and downright buttons, and a numeral key ‘9’ corresponds to inputting a down-right button two times.

20. The apparatus of claim 19, wherein the processing unit outputs one of the keys in the lower 1-by-3 arrangement of the 4-by-3 keypad, each being assigned direction buttons of the direction input unit, by pressing the direction buttons when a left key of the lower 1-by-3 arrangement corresponds to simultaneously inputting down-left and up-left buttons, a right key of the lower 1-by-3 arrangement corresponds to simultaneously inputting down-right and up-right buttons, and a center key of the lower 1-by-3 arrangement corresponds to simultaneously inputting down-left and up-right buttons or simultaneously inputting down-right and up-left buttons.

21. A computer readable recording medium storing a program for executing in a computer the method of claim 1.
